(19) United States
(12) Patent Application Publication
(10) Pub. No.: US 2010/0033025 A1
(43) Pub. Date: Feb. 11, 2010

(54) Power adator having power-saving circuit

(76) Inventor: Sang Hun Lee, San Ramon, CA (US)

Correspondence Address: Patent Office of Dr. Chung S. Park, P.O. Box 62312, Sunnyvale, CA, 94088-2312, US

(21) Appl. No.: 12/462,511

(22) Filed: Aug. 4, 2009

Related U.S. Application Data
(60) Provisional application No. 61/188,571, filed on Aug. 11, 2008.

(51) Int. Cl. H02B 1/24; B23K 11/24

(52) U.S. Cl. 307/116; 307/112

(57) ABSTRACT

A power adaptor for converting AC/DC current to DC current and providing the converted DC current to a portable device. The power adaptor includes a converter and switching means. The converter includes input ports for receiving the input current therethrough and output ports for flowing the output current therethrough. The switching means are coupled to the input ports and operative to control the flow of the input current. The switching means are adapted to be connected to and operated by the portable device such that the input current flows only when the portable device is coupled to the power adaptor.

### FIELD OF THE DISCLOSURE

The present disclosure relates to a power adaptor of a device, and more particularly to a power adaptor having a power-saving circuit.

### BACKGROUND

Portable devices, such as cellular phones, MP3 players, personal digital assistants (PDA), camcorders, digital cameras, laptops, and cordless and mobile phones, have become the essential electric appliances in the modern life. According to the web site http://www.energystar.gov/ia/partners/prod_development/downloads/power_supplies/PSMA.pdf (see Appendix), as many as 1.5 billion portable devices are in use in the U.S. The total energy flowing through all types of power supplies into those portable devices is about 207 billion kWh/year, which amounts to 6% of the national electric bill. Typically, a portable device has an AC/DC (alternating-current/direct-current) adaptor that receives commercial alternating AC current from a wall outlet into a low voltage DC current used to power the device.

A conventional portable device has an internal rechargeable battery so that its user can run the device for several hours without connecting the device to a power outlet. The battery is charged when the portable device is electrically connected to a wall outlet via the AC/DC adaptor. Typically, when the battery is charged up, the user disconnects the device from the AC/DC adaptor, leaving the AC/DC adaptor connected to the wall outlet in an unused mode. In the unused mode, the AC/DC adaptor still uses a certain level of power, resulting in a waste of electrical energy. Considering the number of portable devices in use, the wasted electrical energy may add up to a considerable amount. As such, there is a need for an adaptor having a mechanism to reduce the waste of energy.

### SUMMARY OF THE DISCLOSURE

According to one embodiment, a power adaptor for converting an input current into an output current and providing the output current to a portable device includes a converter and switching means. The converter includes input ports for receiving the input current therethrough and output ports for flowing the output current therethrough. The switching means are coupled to the input ports and operative to control the flow of the input current. The switching means are adapted to be connected to and operated by the portable device such that the input current flows only when the portable device is coupled to the power adaptor.

### BRIEF DESCRIPTION OF THE DRAWINGS

FIG. 1 shows a schematic diagram of a system for providing electrical power to a portable device in accordance with one embodiment of the present invention.

FIG. 2A shows a schematic cross-sectional view of the power adaptor shown in FIG. 1.

FIG. 2B shows schematic cross-sectional views of the adaptor plug and the portable device shown in FIG. 1.

FIG. 3A shows a schematic cross-sectional view of a power adaptor in accordance with another embodiment of the present invention.

FIG. 3B shows schematic cross-sectional views of an adaptor plug and a portable device of a type to be used with the power adaptor of FIG. 3A.

FIG. 4 shows a schematic cross-sectional view of a power adaptor of a type that might be used with the portable device of FIG. 3B in accordance with yet another embodiment of the present teachings.

### DETAILED DESCRIPTION OF THE PREFERRED EMBODIMENTS

Although the following detained description contains many specifics for the purposes of illustration, those of ordinary skill in the art will appreciate that many variations and alterations to the following detains are within the scope of the invention. Accordingly, the following embodiments of the invention are set forth without any loss of generality to, and without imposing limitation upon, the claimed invention.

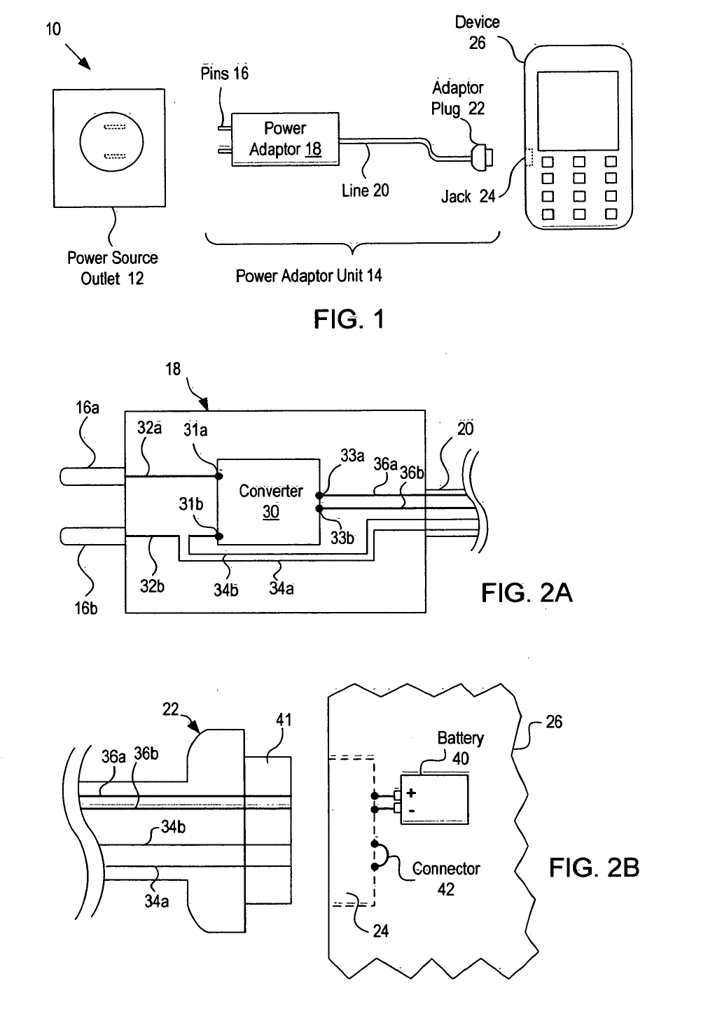

FIG. 1 is a schematic diagram of a system 10 for providing electrical power to a portable device 26 in accordance with one embodiment of the present invention. As depicted, the portable device 26 is connected to the power source outlet 12 via a power adaptor unit 14. For simplicity, in the present document, the power source outlet 12 is shown as a wall socket that provides commercial AC current, i.e., the power adaptor unit 14 is an AC/DC adaptor. However, it should be apparent to those of ordinary skill that the power source outlet 12 is a DC power source outlet and the power adaptor unit 14 is a DC/DC adaptor.

The power adaptor unit 14 includes a power adaptor 18, pins/blades 16, an electrical cable 20, and an adaptor plug 22 disposed at the distal end of the cable 20 and configured to engage the jack 24 of the device 26. It is noted that the power adaptor unit 14 may have other configurations. For example, the power adaptor unit 14 may have an additional plug (not shown in FIG. 1 for brevity) disposed at the proximal end of the power adaptor via another electrical line, and pins are prominently secured to the plug. In another example, the power adaptor unit 14 may include three pins/blades, where one of the pins is connected to a ground during operation.

The power adaptor 18 converts AC current received from the power source outlet 12 via the pins 16 into DC current. FIG. 2A shows a schematic cross-sectional view of the power adaptor 18 shown in FIG. 1. FIG. 2B shows schematic cross-sectional views of the adaptor plug 22 and the portable device 26 shown in FIG. 1. As depicted, one pin 16a is electrically coupled to an input port 31a of a converter 30 of the power adaptor 18 via an input line 32a. The other pin 16b is electrically connected to the other input port 31b of the converter 30 via another input line 32b, where the input line 32b is open. More specifically, the input line 32b includes an indentation and electrical lines 34a and 34b are respectively connected to the ends of the indentation and extend to the distal end of the adaptor plug 22. It is noted that the converter 30 collectively refers to a circuit that converts AC (or DC) current to DC current. For example, the converter 30 may include a transformer and several diodes to rectify the input AC current. In another example, the converter 30 may further include a capacitor for smoothing the pulsating current from the rectifier.

Two output lines 36a, 36b respectively extend from output ports 33a, 33b of the converter 30 to the adaptor plug 22. The cable 20 includes the four lines 34a, 34b, 36a, and 36b disposed therein. The adaptor plug 22 is disposed at the distal end of the cable 20 and has a salient portion 41 that engages the jack 24 of the portable device 26.

The device 26 includes a rechargeable battery 40 and a connector 42, where the connector 42 is formed of a conducting material, such as metal. The battery 40 may include one or more commercially available batter cells, such as Li-Ion, NiCd, and NiMH battery cells. When the user inserts the salient portion 41 into the jack 24, the two ends of the connector 42 are respectively connected to the electrical wires 34a, 34b to thereby close the input line 32b. Also, the electrodes of the battery 40 are respectively connected to the two output lines 36a, 36b.

In the charging mode, the user respectively inserts the pins 16 and the adaptor plug 22 into the power source outlet 12 and the jack 24. Then, the battery 40 is charged by the DC current transmitted from the converter 30 through the output lines 36a, 36b. In the unused mode, the pins 16 may remain inserted into the power source outlet 12 while the portable device 26 is disconnected from the power adaptor 14. In this mode, the line 34a is disconnected from the line 34b, i.e., the input line 32b is open, such that the input port 31b of the converter 30 is disconnected from the power source outlet 12. Thus, the power adaptor 18 does not consume any electrical power in the unused mode even if the user leaves the pins in the power source outlet 12. Stated differently, the electrical lines 34a, 34b form a switch to open/close the input line 32b and the connector 42 functions as the switch operator.

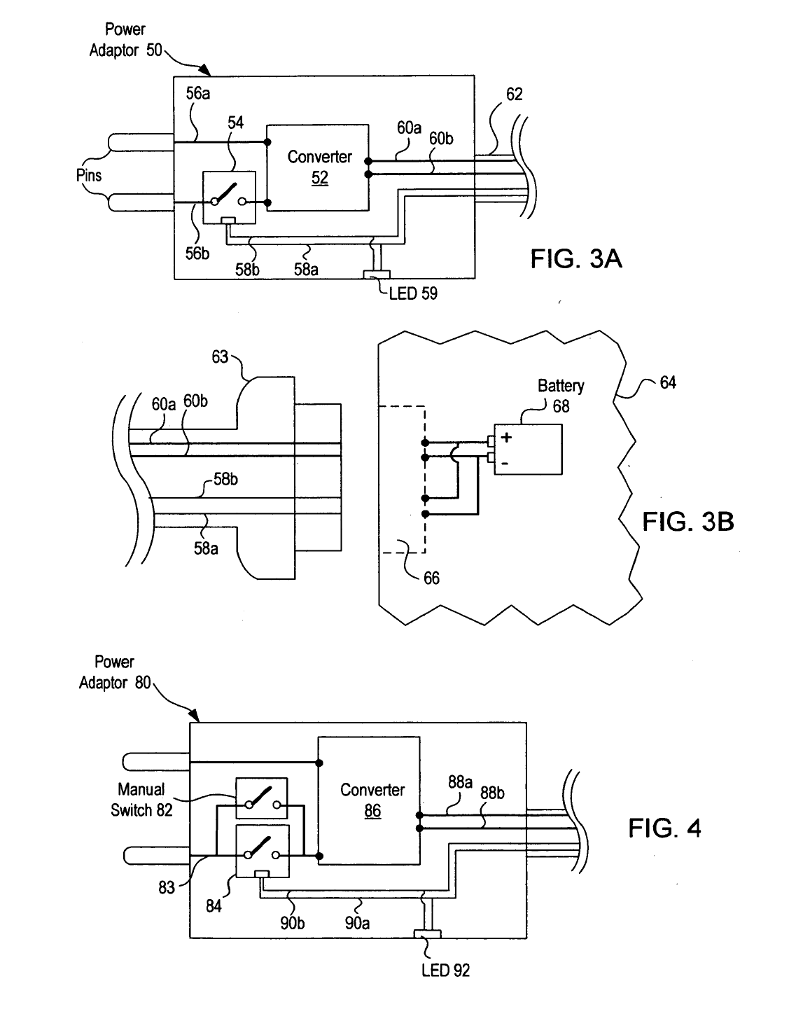

FIG. 3A shows a schematic cross-sectional view of a power adaptor 50 in accordance with another embodiment of the present invention. FIG. 3B shows schematic cross-sectional views of an adaptor plug 63 and a portable device 64 that might be used with the power adaptor 50 of FIG. 3A. As depicted, the power adaptor 50 is similar to the power adaptor 18 in FIG. 1, with the differences that a switch 54 is disposed in the power adaptor 50 and opens or closes one of the input line 56b. The switch 54 is preferably, but not limited to, a relay switch. When the user inserts the adaptor plug 63 into a jack 66 of the portable device 64, the electrical terminals of a battery 68 of the portable device 64 are connected to the two output lines 60a, 60b of the converter 52. Also, the electrical terminals of the battery 68 are connected to the two electrical lines 58a, 58b so that the electrical power remaining in the battery 68 activates the switch 54 and thence the input line 56b is closed. As such, the battery 68 functions as an operator of the switch 54.

During the charging mode, the user inserts the pins into a power source outlet. Then, a converter 52 in the power adaptor 50 receives AC current through input lines 56a, 56b and transmits DC current to the battery 68 via the output lines 60a, 60b. In the charging mode, a portion of the output DC current from the converter 52 is used to maintain the switch 54 in the closed state. In the unused mode, the portable device 64 is disconnected from the adaptor plug 63, causing the switch 54 to open the input line 56b. Thus, in the unused mode, the power adaptor 50 does not consume any electrical power even if the user leaves the pins in the power source outlet.

Optionally, a light-emitting-diode (LED) 59 may be included in the power adaptor 50. The LED 59 is lit only when the switch 54 is activated by the electrical power of the battery 68, to thereby notify the user of the charging status.

FIG. 4 shows a schematic cross-sectional view of a power adaptor 80 of a type that might be used with the portable device 64 of FIG. 3B in accordance with yet another embodiment of the present teachings. The power adaptor 80 is similar to the power adaptor 50 of FIG. 3A, with the difference that the power adaptor 80 includes a manual switch 82 arranged in parallel with a relay switch 84. For simplicity, the adaptor plug of the power adaptor 80, which has the same structure as the adaptor plug 63 of FIG. 3B, is not shown in FIG. 4.

In the case where the battery 68 has sufficient electric power to activate the relay switch 84 via the two electrical lines 90a, 90b, the switch 84 is closed when the user inserts the adaptor plug into the jack 66 of the portable device 64. In this case, the power adaptor 80 operates in the same manner as the power adaptor 50. However, if the remaining power in the battery 68 is not sufficient to activate the switch 84, a user may press the manual switch 82 to close one of the input lines 83 in the charging mode. The user may press the manual switch 82 for a short time interval until the relay switch 84 is activated by the output DC current from the converter 86. Once the relay switch 84 is activated to close the input line 83, the battery 68 is charged via the output lines 88a, 88b even when the user releases the manual switch 82.

In the unused mode, the user disconnects the portable device 64 from the power adaptor 80, causing the relay switch 84 to be open. In this mode, even if the pins remain inserted into the power source outlet, the power adaptor 80 does not consume any electrical power insofar as the user does not press the manual switch 82.

Optionally, an LED 92 may be included in the power adaptor 80. The LED 92 is lit only when the relay switch 84 is activated by the electrical power of the battery 68, to thereby notify the user of the charging status.

It is noted that the devices 26 and 64 in FIGS. 1-4 include conventional portable devices, such as cellular phones, MP3 players, personal digital assistants (PDA), camcorders, digital cameras, laptops, and cordless and mobile phones, etc. However, it should be apparent to those of ordinary skill in the art that the devices are not necessarily limited to portable devices and that the devices include any suitable electric appliances powered via power adaptors.

While the present invention has been described with reference to the specific embodiments thereof, it should be understood that the foregoing relates to preferred embodiments of the invention and that modifications may be made without departing from the spirit and scope of the invention as set forth in the following claims.

What is claimed is:

1. A power adaptor for converting an input current into an output current and providing the output current to a device, comprising:
a converter including:
input ports for receiving the input current therethrough; and
output ports for flowing the output current therethrough; and
switching means coupled to the input ports and operative to control a flow of the input current;
wherein the switching means are adapted to be connected to and operated by the device such that the input current flows only when the device is coupled to the power adaptor.

2. A power adaptor as recited in claim 1, further comprising:
an input line connected to one of the input ports and having an indentation; and
a cable having a proximal end connected to the converter,
wherein the switching means include two electrical lines connected to two ends of the indentation and extending through the cable to a distal end of the cable and wherein the device includes a connector adapted to connect the two electrical lines when the device is connected to the distal end of the cable.

3. A power adaptor as recited in claim 2, further comprising:
output lines connected to the output ports and extending through the cable to the distal end of the cable,
wherein the device includes a battery having terminals adapted to be connected to the output lines when the device is connected to the distal end of the cable.

4. A power adaptor as recited in claim 1, further comprising:
an input line connected to one of the input ports; and
a cable having a proximal end connected to the converter,
wherein the switching means include a switch disposed in the input line and two electrical lines extending from the switch to a distal end of the cable and wherein device includes a battery having two terminals adapted to be respectively connected to the two electrical lines when the device is connected to the distal end of the cable and wherein the switch is operated by an electrical power supplied from the battery via the two electrical lines.

5. A power adaptor as recited in claim 4, further comprising:
output lines connected to the output ports and extending through the cable to the distal end of the cable,
wherein the two terminals of the battery are adapted to be respectively connected to the two output lines when the device is connected to the distal end of the cable.

6. A power adaptor as recited in claim 4, wherein the switch is a relay switch.

7. A power adaptor as recited in claim 4, further comprising:
a manual switch disposed in parallel with the switch.

8. A power adaptor as recited in claim 4, further comprising:
a light-emitting-diode coupled to the two electrical lines and operative to notify a user of a charging status of the battery.
